(19) United States
(12) Patent Application Publication
(10) Pub. No.: US 2025/0020452 A1
(43) Pub. Date: Jan. 16, 2025

(54) DISPLACEMENT MEASUREMENT APPARATUS, NON-CONTACT INPUT APPARATUS, AND BIOLOGICAL MICROMOTION MEASUREMENT APPARATUS

(71) Applicants: Suguru SANGU, Kanagawa (JP); Yuki ABE, Kanagawa (JP)

(72) Inventors: Suguru SANGU, Kanagawa (JP); Yuki ABE, Kanagawa (JP)

(21) Appl. No.: 18/710,644

(22) PCT Filed: Dec. 20, 2022
(86) PCT No.: PCT/IB2022/062510

§ 371 Date: May 16, 2024

(30) Foreign Application Priority Data
Dec. 28, 2021 (JP) 2021-214739

(51) Int. Cl. G01B 11/16; G06F 3/01; G06F 3/03

(52) U.S. Cl. CPC G01B 11/162; G06F 3/011; G06F 3/017; G06F 3/0317

(57) ABSTRACT

A displacement measurement apparatus includes: a light emitter to emit coherent light to an object; a light position detector to detect an instantaneous intensity variation of an interference image of the object; and an interference imaging forming unit disposed between the object and the light position detector along an optical path of reflection light reflected from the object. The interference imaging forming unit forms the interference image with the reflection light reflected from the object and magnifies a point spread function of an optical system to magnify a size of a speckle particle of the interference image.

### TECHNICAL FIELD

The present disclosure relates to a displacement measurement apparatus, a non-contact input apparatus, and a biological micromotion measurement apparatus.

### BACKGROUND ART

NPL1 listed below discloses a technique for measuring the amount of a minute displacement of an object. In the technique, an event-based vision sensor acquires a speckle pattern, generates a speckle pattern image, and performs image processing on the image of the speckle pattern to obtain the minute displacement of the object.

NPL1 also discloses a configuration of the apparatus for measuring the amount of a minute displacement. The apparatus includes a lasers light source, a beam expander, a lens, and an event-based vision sensor.

### Citation List

### Non Patent Literature

### [NPL 1]

Zhou Ge, Yizhao Gao, Hayden K.-H. So, and Edmund Y. Lam, “Event-based laser speckle correlation for micro motion estimation”, Optics Letters 46 (2021)

### SUMMARY OF INVENTION

### Technical Problem

However, in a displacement measurement technique using the typical event-based vision sensor and the speckle pattern image, the amount of a minute displacement of the object is hard to measure with higher accuracy because the speckle pattern having a sufficient texture size to calculate the displacement of the image of the speckle pattern in the spatial correlation calculation is not formed on the light receiving surface of the photodetector unless the distance between the object and the photodetector is set to be longer.

In view of the above circumstances, embodiments of the present invention aim at providing a displacement measurement apparatus to detect the amount of a minute displacement of an object with higher accuracy, a non-contact input apparatus, and a biological micromotion measurement system.

### Solution to Problem

A displacement measurement apparatus includes: a light emitter to emit coherent light to an object; a light position detector to detect an instantaneous intensity variation of an interference image of the object; and an interference imaging forming unit disposed between the object and the light position detector along an optical path of reflection light reflected from the object. The interference imaging forming unit forms the interference image with the reflection light reflected from the object and magnifies a point spread function of an optical system to magnify a size of a speckle particle of the interference image.

Further, an embodiment of the present disclosure provides a displacement measurement apparatus including: a light emitter to emit coherent light to an object; a light position detector to detect an instantaneous intensity variation of an interference image of the object; and a spatial distribution providing unit disposed between the light emitter and the object along an optical path of the coherent light. The spatial distribution providing unit provides a spatial distribution to the coherent light.

Further, an embodiment of the present disclosure provides a non-contact input apparatus including the displacement measurement apparatus described above.

Further, an embodiment of the present disclosure provides a biological micromotion measurement apparatus including the displacement measurement apparatus described above.

### Advantageous Effects of Invention

According to the embodiments of the present invention, a displacement measurement apparatus to measure the amount of a minute displacement of the object with higher accuracy, a non-contact input apparatus and a biological micromotion measurement apparatus provided with the displacement measurement system are provided.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram of an overall configuration of a displacement measurement apparatus according to a first embodiment;

FIG. 2A is a diagram of a speckle image formed on a light receiving surface of an event-based vision sensor as an example of the output of event data by the light position detector in the displacement measurement apparatus according to the first embodiment;

FIG. 2B is a diagram of the speckle image formed on a light receiving surface of the event-based vision sensor and having a minute displacement from the speckle image in FIG. 2A;

FIG. 2C is a diagram of even data including the speckle images in FIG. 2A and FIG. 2B as an example;

FIG. 3A is a diagram of a speckle image acquired by the typical image sensor as a comparative example;

FIG. 3B is a diagram of a speckle image acquired by the event-based vision sensor according to the first embodiment;

FIG. 4A is a diagram of a frame image at time t used in a displacement estimation method by an interference measurement system in the displacement measurement apparatus according to the first embodiment;

FIG. 4B is a diagram of a frame image at time t+Δt used in a displacement estimation method by an interference measurement system in the displacement measurement apparatus;

FIG. 4C is a diagram of a cross-correlation function calculated by the frame images in FIGS. 4A and 4B in the displacement estimation method;

FIG. 5A is a diagram of a configuration of a typical interference imaging optical system in a displacement measurement apparatus as a comparative example;

FIG. 5B is a diagram of a configuration of an interference imaging optical system in the displacement measurement apparatus according to the first embodiment;

FIG. 5C is a diagram of another configuration of an interference imaging optical system in the displacement measurement apparatus according to the first embodiment;

FIG. 6 is a flowchart of a processing procedure by an information processor in the displacement measurement apparatus according to the first embodiment;

FIG. 7A is a diagram of an event data group arranged in a temporal sequence used in a conversion method from the event data into a frame matrix by the information processor;

FIG. 7B is a diagram of the event data group having numerical values as an example;

FIG. 7C is a diagram of an initial frame matrix before time accumulation;

FIG. 7D is a diagram of an initial frame matrix before time accumulation;

FIG. 8 is a diagram of an overall configuration of a displacement measurement apparatus according to a second embodiment;

FIG. 9A is a diagram of a spatial distribution providing unit as a first configuration in the displacement measurement apparatus according to the second embodiment;

FIG. 9B is a diagram of a spatial distribution providing unit as a second configuration in the displacement measurement apparatus according to the second embodiment;

FIG. 9C is a diagram of a spatial distribution providing unit as a third configuration in the displacement measurement apparatus according to the second embodiment;

FIG. 10 is a diagram of a non-contact input apparatus as a first example of a displacement measurement apparatus according to an embodiment;

FIG. 11 is a cross-sectional view of the non-contact input apparatus in FIG. 10;

FIG. 12 is a diagram of a tremor measurement apparatus as a second example of the displacement measurement apparatus according to an embodiment;

FIG. 13 is a cross-sectional view of the tremor measurement apparatus in FIG. 12.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an embodiment will be described with reference to the drawings.

### First Embodiment

### Overall Configuration of Displacement Measurement Apparatus

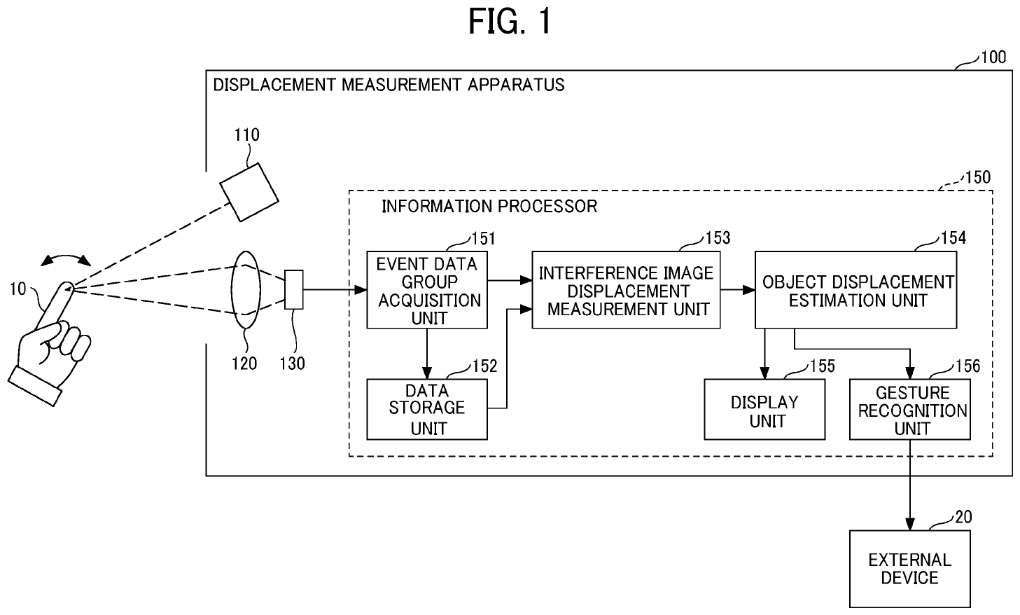

FIG. 1 is a diagram of an overall configuration of a displacement measurement apparatus 100 according to the first embodiment. In the displacement measurement apparatus 100 illustrated in FIG. 1, the light emitter emits coherent light to the object 10 (e.g., a human hand) to be measured, the coherent light is reflected by the object as reflected light, and the reflected light from the object forms an interference image. The displacement measurement apparatus 100 measures the amount of a minute displacement of the object 10 based on an event data group indicating instantaneous intensity variation of the interference image. The amount of a minute displacement of the object 10 measured by the displacement measurement apparatus 100 is displayed to a user or used to control of the external device 20. The external device 20 performs, for example, an operation of a personal computer or a television (e.g., page turning, volume adjustment, or icon selection), a light fixture (e.g., turning on and off), a security lock (e.g., locking and unlocking), a robot, or an inspection apparatus (e.g., direction).

As illustrated in FIG. 1, the displacement measurement apparatus 100 includes a light emitter 110, which is also referred to as a light projection unit, an interference image forming unit 120, a light position detector 130, and an information processor 150.

The light emitter 110 emits coherent light to the object 10. Preferably, the light emitter 110 is a laser light source that emits higher coherence light so that the interference image formed by the reflected light from the object is formed on the light receiving surface of the light position detector 130. Examples of the light emitter 110 include a laser diode (LD), a vertical cavity surface emitting laser (VCSEL), or a small gas laser.

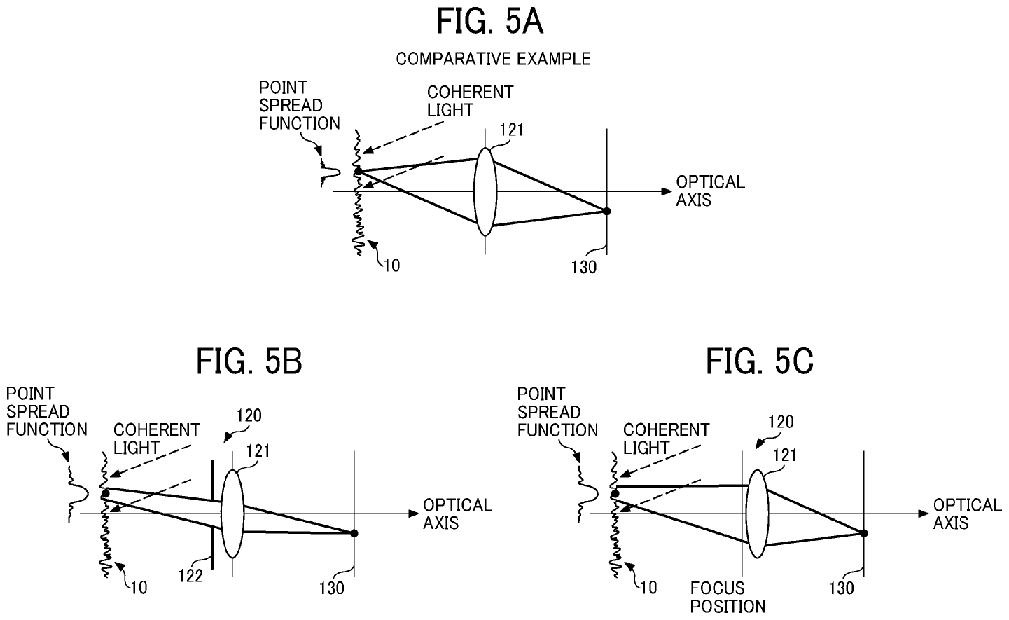

The interference image forming unit 120 forms an interference image from the light reflected by the object 10. In other words, the interference images is formed by coherent light reflected by the object 10. In the present embodiment, the interference image forming unit 120 is disposed between the object 10 and the light position detector 130 along the optical path of the reflection light from the object 10. The interference image forming unit 120 has a function of adjusting the characteristics of the interference image so that the amount of a displacement of the object 10 is appropriately acquired. A configuration of the interference image forming unit 120 will be described in detail with reference to FIG. 5.

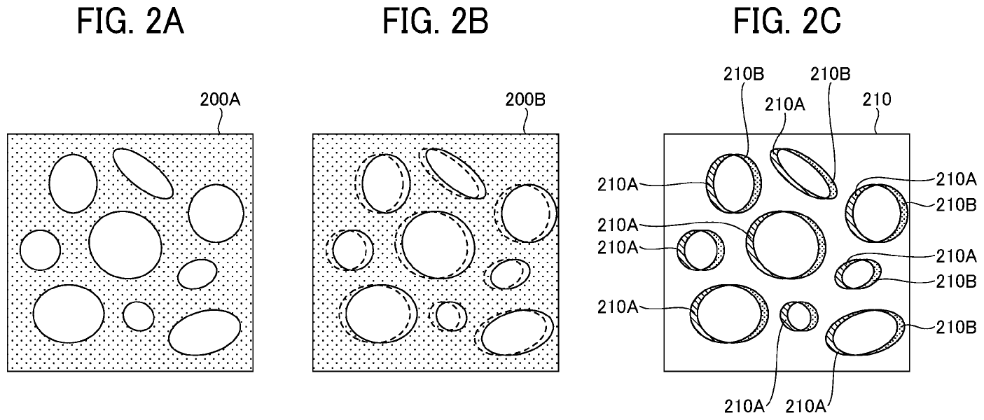

The light position detector 130 detects an instantaneous intensity variation of the interference image formed by the interference image forming unit 120. In the present embodiment, an event-based camera provided with an event-based vision sensor is used as the light position detector 130, which detects an instantaneous intensity variation. The light position detector 130 outputs an event data group indicating an instantaneous intensity variation of the detected interference image. The event data group is a digitized numerical data string and a time-series data group of a signal including a time (T), an event occurrence pixel position (X, Y), and a polarity (P) of a luminance variation with respect to a pixel in which a luminance variation equal to or greater than a predetermined value occurs. The event-based vision sensor will be described later in detail with reference to FIG. 2. Herein, “detecting an instantaneous intensity variation of an interference image” detects an intensity change of luminance of the interference image in an extremely short time and at an extremely high speed.

As an example of the interference image formed by the interference image forming unit 120, a speckle image of a random interference image caused by the surface roughness of the object 10 is used. The speckle image is caused by the characteristics of light waves, and changes the luminance distribution of the image very sensitively to the movement of the object 10. The speckle image is obtained by scale conversion of sensitivity to a level at which a minute displacement of the object 10 is acquired on the imaging surface (the light receiving surface) of the light position detector 130. In the present embodiment, an event-based vision sensor having a higher-speed frame rate is used as the light position detector 130. Thus, a speckle image that changes sharply is acquired at higher speed, and a minute displacement of the object 10 is reliably acquired.

In the displacement measurement apparatus, the light position detector is an event-based vision sensor.

The information processor 150 includes an event data group acquisition unit 151, a data storage unit 152, an interference image displacement measurement unit 153, an object displacement estimation unit 154, a display unit 155, and a gesture recognition unit 156.

The event data group acquisition unit 151 acquires an event data group output from the light position detector 130.

The data storage unit 152 works as a buffer that temporarily stores the event data group acquired by the event data group acquisition unit 151.

The interference image displacement measurement unit 153 measures the amount of a displacement in the interference image based on the event data group (first event data group) stored in the data storage unit 152 and the event data group (second event data group) newly acquired by the event data group acquisition unit 151. Specifically, the interference image displacement measurement unit 153 generates two frame matrices by converting the first event data group and the second event data group into a frame matrices. Each frame matrix is equivalent to a frame image. The interference image displacement measurement unit 153 calculates a cross-correlation function between the two frame matrices and acquires correlation peak coordinates (i.e., a coordinates in a pixel unit of the event-based vision sensor) at which the correlation peak value indicates a maximum value as the amount of the displacement in the interference image.

The object displacement estimation unit 154 converts the correlation peak coordinates acquired by the interference image displacement measurement unit 153 into the amount of the actual displacement (i.e., length) in an actual space in which the object exists.

The display unit 155 displays the amount of the actual displacement obtained by the amount of the object displacement estimation unit 154.

The gesture recognition unit 156 recognizes a gesture performed by the object 10 based on the amount of the actual displacement obtained by the object displacement estimation unit 154. The gesture recognition unit 156 outputs the recognition result of the gesture by the object 10 to the external device 20. Thus, the external device 20 executes processing corresponding to the gesture by the object 10. The external device 20 performs, for example, an operation of a personal computer or a television (e.g., page turning, volume adjustment, or icon selection), a light fixture (e.g., turning on and off), a security lock (e.g., locking and unlocking), a robot, or an inspection apparatus (e.g., direction).

Each function of the information processor 150 is achieved by one or multiple processing circuits. Herein, the “processing circuit” includes a processor programmed to perform each function by software such as a processor implemented by an electronic circuit, and a device such as an application specific integrated circuit (ASIC), a digital signal processor (DSP), a field programmable gate array (FPGA), or a typical circuit module designed to perform each function described above.

Example of Output of Event Data from Light Position Detector

FIG. 2A to 2C are diagrams of event data output from the light position detector 130 in the displacement measurement apparatus 100 according to the first embodiment.

FIGS. 2A and 2B are diagrams of a speckle image formed on the light receiving surface of the event-based vision sensor. FIG. 2A is a speckle image 200A at time t. FIG. 2B is a speckle image 200B at time t+Δt. FIG. 2C is a diagram of event data output from the light position detector 130. The event data 210 is generated based on the speckle images illustrated in FIGS. 2A and 2B.

The light position detector 130 includes the event-based vision sensor, and the event-based vision sensor outputs a signal including a time (T), a pixel position (X, Y), and a polarity (P) of a luminance variation in response to an event occurrence. The event occurrence is a timing when a pixel in which the luminance variation exceeds a predetermined threshold is detected. The polarity (P) takes two values of 1 for increase and 0 for decrease.

For example, when a speckle image 200A (FIG. 2A) at time t horizontally moves to a speckle image 200B (FIG. 2B) at time t+Δt (i.e., time is changed by Δt), the polarity of the luminance variation of the event-based vision sensor at time t+Δt is spatially distributed with increasing components 210A (lightly shaded areas in the figure) in which the brightness is a certain value or above and with decreasing components 210B (darkly shaded areas in the figure) in which the brightness is the certain value or below in the event data 210 as illustrated in FIG. 2C.

In such a case, the event-based vision sensor outputs a group of a time-series signal including a signal detection time (T), a pixel position (X, Y), and a polarity of 1 for increasing with respect to all pixels in the increasing components 210A. By contrast, the event-based vision sensor outputs a group of a time-series signal including a signal detection time (T), a pixel position (X, Y), and a polarity of 0 for decreasing for all pixels in the decreasing components 210B. In such a case, the event-based vision sensor does not output data for all remaining pixels in other regions (unshaded areas in the drawing) corresponding to neither the regions of the increasing components 210A nor the regions of the decreasing components 210B. Thus, the event data 210 output from the event-based vision sensor has an extremely small data amount as compared with the frame image data.

As described above, the event-based vision sensor is not limited by the frame rate and outputs information on the displacement of the speckle image as event data at a higher speed as compared with an image sensor that outputs frame image data.

For example, an event-based vision sensor has a sampling time of about 1 to 200 us for all events in light receiving surface (imaging surface). The frame rate of the event-based vision sensor is much faster than that of a typical video camera. The light position detector 130 includes the event-based vision sensor, and the event-based vision sensor detects the amount of a displacement of the speckle image, which sensitively changes with respect to the displacement of the object 10, at higher speed and reliably.

### Images Acquisition by Light Position Detector

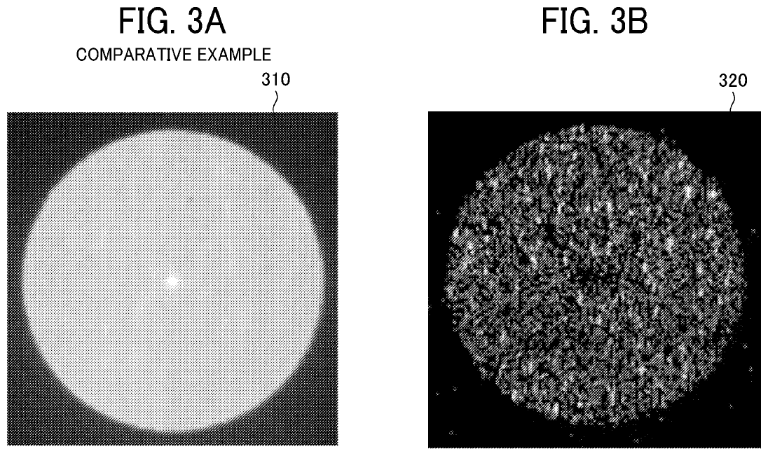

FIGS. 3A and 3B are diagrams of images acquired by a typical image sensor and the light position detector 130 (event-based vision sensor) in the displacement measurement apparatus 100 according to the first embodiment.

In FIG. 3A, an image 310 was acquired by a typical image sensor as a comparative example. In FIG. 3B, an image 320 was an image reconstructed by the light position detector 130 (i.e., event-based vision sensor) in the present embodiment. In the both images, He—Ne laser was emitted to the back of a human hand as the object 10, and both images were acquired by reflected light from the back of the human hand.

In FIG. 3A, the image 310 is a speckle image (speckle particles or texture) acquired by a typical image sensor at a constant frame rate. However, a sufficient contrast of the speckle image is not obtained because the speckle moves at higher speed due to trembling of the hand and the spatial distribution changes abruptly, so that the image of speckle particles become dull (i.e., motion blur) during the exposure time within the frame rate.

By contrast, as illustrated in FIG. 3B, the image 320 is reconstructed by the light position detector 130 (event-based vision sensor). The image 320 is obtained by integrating event data acquired by the event-based vision sensor in a time sufficiently shorter than the exposure time of a typical image sensor and forming a frame image. As described above, the displacement measurement apparatus 100 according to the first embodiment uses the event-based vision sensor as the light position detector 130, and thus acquires the speckle particle having higher contrast even in an environment in which the object 10 moves or fluctuates.

### Displacement Estimation Method by Interference Image Displacement Measurement Unit

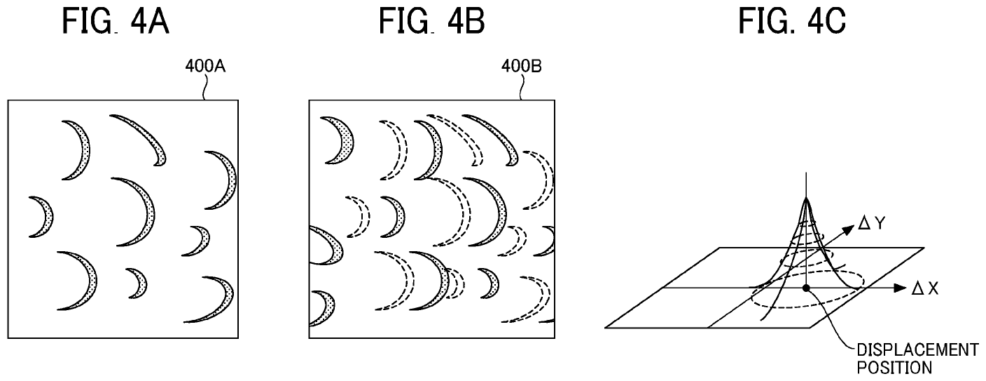

The amount of the displacement of the interference image is estimated by the interference image displacement measurement unit 153 in the displacement measurement apparatus 100 according to the first embodiment. The method will be described with reference to FIGS. 4A to 4C.

FIGS. 4A and 4B are frame images generated by event data output from the event-based vision sensor. FIG. 4A is the frame image 400A at time t (first pattern). FIG. 4B is the frame image 400B at time t+Δts (second pattern). In the frame images 400A and 400B, only the increasing components 410 that increase the luminance by a certain value or more are illustrated. FIG. 4C is a diagram of the cross-correlation function calculated based on the frame images 400A and 400B.

In order to acquire the frame image 400A in FIG. 4A from the time-series date of the event-based vision sensor, the interference image displacement measurement unit 153 sets an integration time for calculating a unit frame, prepares a two-dimensional matrix representing an image, and counts the number of times that a matrix number corresponding to a pixel position appears within the integration time.

As illustrated in FIG. 4B, the interference image displacement measurement unit 153 counts the number of appearance times of the matrix number within the integration time by using the time of the frame image 400A in FIG. 4A.

In FIG. 4B, the first pattern of the frame image 400A in FIG. 4A at time t is represented by the regions enclosed by broken lines, and the second pattern of the frame image 400B at time t+Δts is represented by shaded regions. The first pattern moves to the second pattern as translation in FIG. 4B.

The interference image displacement measurement unit 153 calculates a cross-correlation function (FIG. 4C) between the frame image 400A and the frame image 400B.

As illustrated in FIG. 4C, when the variables of the correlation function (i.e., the displacement amounts) are represented by ΔX-axis and ΔY-axis, the peak value of the cross-correlation function is obtained at a distance and a position (pixel displacement amount on the image) corresponding to the translation amount of the speckle pattern. Herein, ΔX-axis and ΔY-axis are parallel to the X-axis and Y-axis, respectively. For example, the interference image displacement measurement unit 153 calculates the cross-correlation function illustrated in FIG. 4C by shifting either the frame image 400A or the frame image 400B along the X-axis and the Y-axis and integrating the images in the overlapping region.

In addition, a calculation method, which is referred to as Wiener-Khinchin theorem, may calculate the cross-correlation function in the interference image displacement measurement unit 153. In the method, the frame images 400A and 400B are Fourier-transformed (Fourier-transformed results), one complex conjugate of the Fourier-transformed results is multiplied by the other complex conjugate (multiplied result), and the multiple result is inversely Fourier-transformed to obtain the cross-correlation function.

Further, the interference image displacement measurement unit 153 may use a phase only correlation method as a further advanced method based on the Wiener-Khinchin theorem described above. In the phase-only correlation method, two frame images are Fourier-transformed, and complex data is obtained. With respect to the complex data, an amplitude of each pixel is calculated, and a pixel value is normalized by the amplitude to redefine the pixel value. In other words, the object to obtain the correlation is limited to only the phase information in the Fourier space by smoothing luminance information. One complex conjugate of the two normalized data is multiplied by the other complex conjugate (multiplied result), and the multiplied result is inversely Fourier transformed to obtain a peak value equivalent to the correlation function described above.

When the phase only correlation method is used, the shape of the cross-correlation function is converted into a sharper shape (i.e., close to a delta function) by smoothing the luminance information, and the position estimation accuracy of the amount of a displacement is improved. In addition, the peak position of the amount of a displacement with a resolution of one pixel or less is estimated by fitting with a predetermined function.

### Example of Configuration of Interference Image Forming Unit

FIGS. 5A to 5C are diagrams of the configuration of the interference image forming unit 120 in the displacement measurement apparatus 100 according to the first embodiment. FIG. 5A is a diagram of a configuration of an imaging optical system in a typical displacement measurement apparatus. FIGS. 5B and 5C are diagrams of configurations of imaging optical systems in the displacement measurement apparatus 100 according to the first embodiment.

In the configuration of the typical imaging optical system illustrated in FIG. 5A, since the distribution of the point spread function does not have a sufficient width, the speckle particle does not have a sufficient size. In such a case, since the size of the speckle particle is smaller than the pixel size of the event-based vision sensor, multiple speckle particles are included in the same pixel of the event-based vision sensor. As a result, the contrast of the speckle pattern is reduced, and clear correlation peak coordinates of the cross-correlation function may not be obtained in the acquisition processing of the correlation peak coordinates (i.e., the amount of a displacement in the interference image) by the interference image displacement measurement unit 153. The size of the speckle particle having a sufficient size is larger than the pixel size of the event-based vision sensor and is a size for sufficient averaging. Preferably, the number of speckle particles is 10 or more in one axis for sufficient averaging. The size of the speckle particles depends on the broadness of the distribution of the point spread function of the optical system. Thus, the size of the speckle particle is increased by magnifying the distribution of the point spread function to reach a sufficient speckle particle size. In FIGS. 5A to 5C, the width of the point spread function is determined by the region in which one pixel of the light position detector 130 receives the reflected light within the surface of the object 10.

In a case of magnifying the distribution of the point spread function, the imaging optical element 121 moves forward or backward along the optical path to adjust the distance to the object or the light position detector so that the magnification of the imaging optical element 121 is decreased. However, in such a case, the total length of the imaging optical system may become longer, and the apparatus may become larger.

Thus, as illustrated in FIGS. 5B and 5C, the displacement measurement apparatus 100 according to the first embodiment includes an interference image forming unit 120 between the object 10 and the light position detector 130. Accordingly, the displacement measurement apparatus 100 magnifies or blunts the distribution of the point spread function, and adjusts the size of the speckle particle to be an appropriate size without changing the total length of the imaging optical system.

In the example in FIG. 5B, the interference image forming unit 120 includes an imaging optical element 121 and a finite aperture 122 (i.e., a stop) provided in front of the imaging optical element 121. The finite aperture 122 may be provided behind the imaging optical element 121. Accordingly, the interference image forming unit 120 reduces the resolution of the imaging optical system, that is, magnifies the distribution of the point spread function, by reducing the emission region on the imaging optical element 121. The finite aperture 122 is an example of an amplitude modulation filter that partially transmits reflection light.

In the displacement measurement apparatus, the interference image forming unit includes: an imaging optical element; and an amplitude modification filter that partially transmits the reflection light.

In the displacement measurement apparatus, the amplitude modification filter that partially transmits the reflection light is an aperture.

In the example in FIG. 5C, the interference image forming unit 120 includes an imaging optical element 121. In FIG. 5C, the interference image forming unit 120 has a configuration in which the position of the imaging optical element 121 is offset from the focus position and disposed toward the light position detector 130. In other words, the interference image forming unit 120 has a defocused configuration. Accordingly, the interference image forming unit 120 magnifies the distribution of the point spread function. The interference image forming unit 120 may have a configuration in which the imaging optical element 121 is disposed toward the object 10 (i.e., offset from the focus position), a configuration in which the light position detector 130 is disposed toward the imaging optical element 121, or a configuration in which the light position detector 130 is offset away from the imaging optical element 121. In any cases, the distribution of the point spread function is spread.

In the displacement measurement apparatus, the interference image forming unit includes an imaging optical element offset from a focus position toward the light position detector or the object.

In the displacement measurement apparatus, the interference image forming unit includes an imaging optical element to form an image of the reflection light on a predetermined position, and the light position detector is offset from the predetermined position toward or away from the imaging optical element.

In the displacement measurement apparatus further includes an offset position variable unit to offset the imaging optical element or the light position detector.

As described above, the displacement measurement apparatus 100 according to the first embodiment magnifies the distribution of the point spread function by providing the imaging optical element 121 between the object 10 and the light position detector 130. As a result, the displacement measurement apparatus 100 has a resolution of the speckle particle size and measures the amount of a displacement of the speckle image associated with the displacement of the object.

A displacement measurement apparatus includes: a light emitter to emit coherent light to an object; a light position detector to detect an instantaneous intensity variation of an interference image of the object; and an interference imaging forming unit disposed between the object and the light position detector along an optical path of reflection light reflected from the object. The interference imaging forming unit forms the interference image with the reflection light reflected from the object and magnifies a point spread function of an optical system to magnify a size of a speckle particle of the interference image.

### Example of Processing Procedure by Information Processor

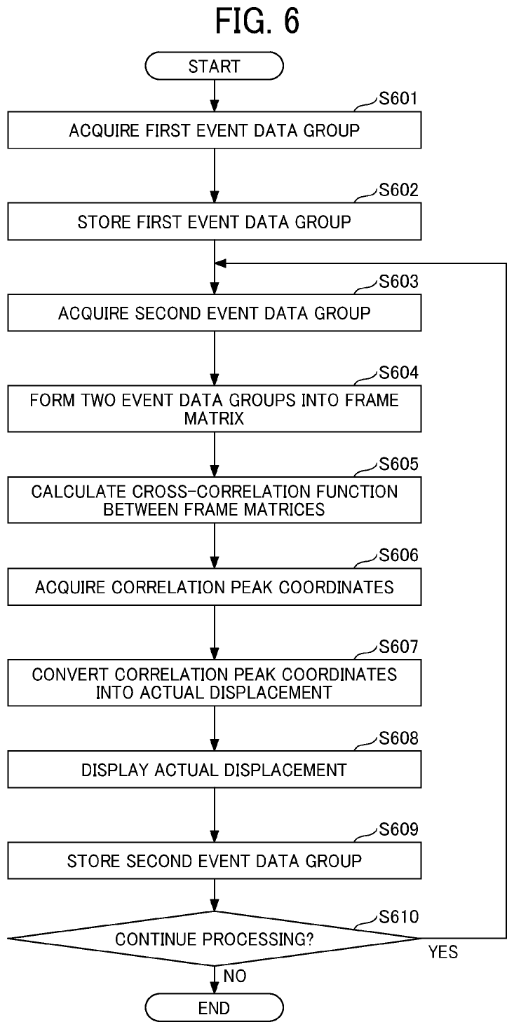

FIG. 6 is a flowchart of a processing procedure in the information processor 150 in the displacement measurement apparatus 100 according to the first embodiment.

In S601, the event data group acquisition unit 151 acquires an event data group output from the light position detector 130 as a first event data group. In S602, the event data group acquisition unit 151 stores the first event data group acquired in S601 in the data storage unit 152.

In S603, the event data group acquisition unit 151 acquires an event data group output from the light position detector 130 as a second event data group.

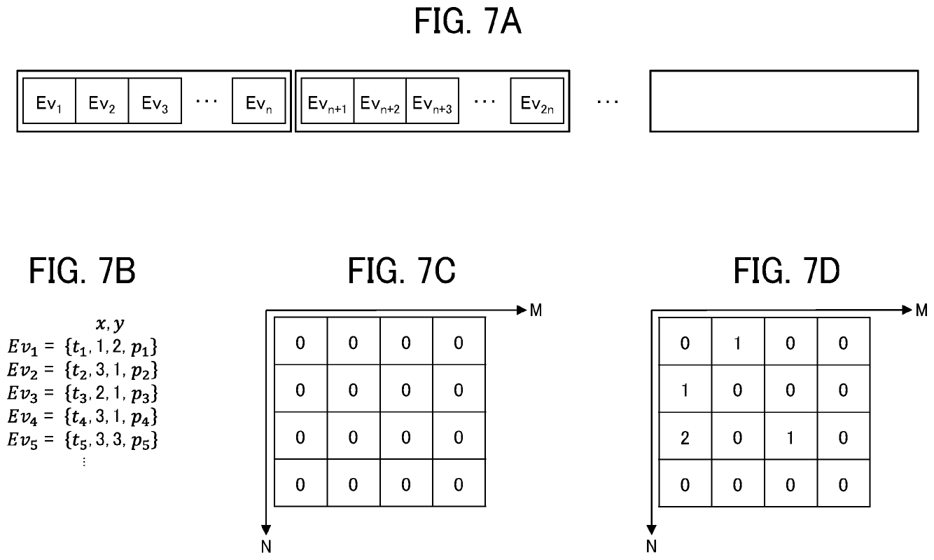

In S604, the interference image displacement measurement unit 153 generates two frame matrices by converting each of the first event data group stored in the data storage unit 152 and the second event data group acquired in S603 into frame matrices. A method of generating the frame matrix will be described later with reference to FIG. 7.

In S605, the interference image displacement measurement unit 153 calculates a cross-correlation function between the two frame matrices generated in S604, and acquires a correlation peak coordinate (a coordinate in a pixel unit of the event-based vision sensor) in which the correlation peak value indicates a maximum value as a shift amount in the interferogram in S606.

In S607, the object displacement estimation unit 154 converts the correlation peak coordinates acquired in S606 into an actual displacement amount that is a length in the actual space in which the object 10 exists.

In S608, the display unit 155 displays the actual displacement obtained in S607. Thus, the user may utilize the amount of the actual displacement displayed on the display unit 155.

In S609, the event data group acquisition unit 151 stores the second event data group acquired in S603 in the data storage unit 152 as a new first event data group.

In S610, the information processor 150 determines whether the processing continues or not.

In a case where the process is determined to continue in S610 (YES), the information processor 150 returns the process to S603.

In a case where the process is determined not to continue in S610 (NO), the information processor 150 ends the series of process illustrated in FIG. 6.

Conversion Method from Event Data into Frame Matrix

The information processor 150 in the displacement measurement apparatus 100 according to the first embodiment converts the event data into a frame matrix. The method will be described with reference to FIGS. 7A to 7D.

In the displacement measurement apparatus 100 according to the first embodiment, one piece of event data output from the light position detector 130 (i.e., event-based vision sensor) has a sequence of numerical values represented by the expression (1) below.

$$Evi = \{ ti , xi , yi , pi \} \qquad ( 1 )$$

In addition, as illustrated in FIG. 7A, the output of the light position detector 130 is, for example, an event data group in a finite time unit arranged in time series.

For example, the interference image displacement measurement unit 153 prepares an initial array of M rows and N columns to generate a frame matrix having N×M pixels from the event data group in the time intervals from t1 to tn, and time-integrates the number of arrays (yi rows and xi columns) corresponding to the coordinates (xi, yi) of the event-data at each time ti in the time intervals from t1 to tn.

For example, when acquiring the event data group in FIG. 7B, the interference image displacement measurement unit 153 generates an array after the time integration illustrated in FIG. 7D by time integrating on the initial array in FIG. 7C. The time-integrated array generated in such a way is referred to as a frame matrix. Similarly, the interference image displacement measurement unit 153 generates one frame matrix from one event data group.

### Effects

As described above, the displacement measurement apparatus 100 according to the first embodiment includes the light emitter 110 that emits coherent light to the object 10, the interference image forming unit 120 that forms an interference image from light reflected by the object 10, and the light position detector 130 that detects an instantaneous intensity variation of the interference image, and the interference image forming unit 120 is disposed between the object 10 and the light position detector 130 along the optical path of the reflected light.

Accordingly, the displacement measurement apparatus 100 according to the first embodiment acquires the higher-speed displacement of the interference image caused by the displacement of the object 10, and calculates the amount of a displacement with higher accuracy. Further, in the displacement measurement apparatus 100 according to the first embodiment, since the interference image forming unit 120 is provided between the object 10 and the light position detector 130, the size of the speckle particle of the interference image acquired in the light position detector 130 is adjusted to a size to calculate the displacement of the object 10 with higher accuracy without increasing the size of the measurement optical system.

Thus, according to the displacement measurement apparatus 100 according to the first embodiment, a small-sized displacement measurement apparatus to measure the amount of a minute displacement of an object with higher accuracy is provided.

### Second Embodiment

### Overall Configuration of Displacement Measurement Apparatus

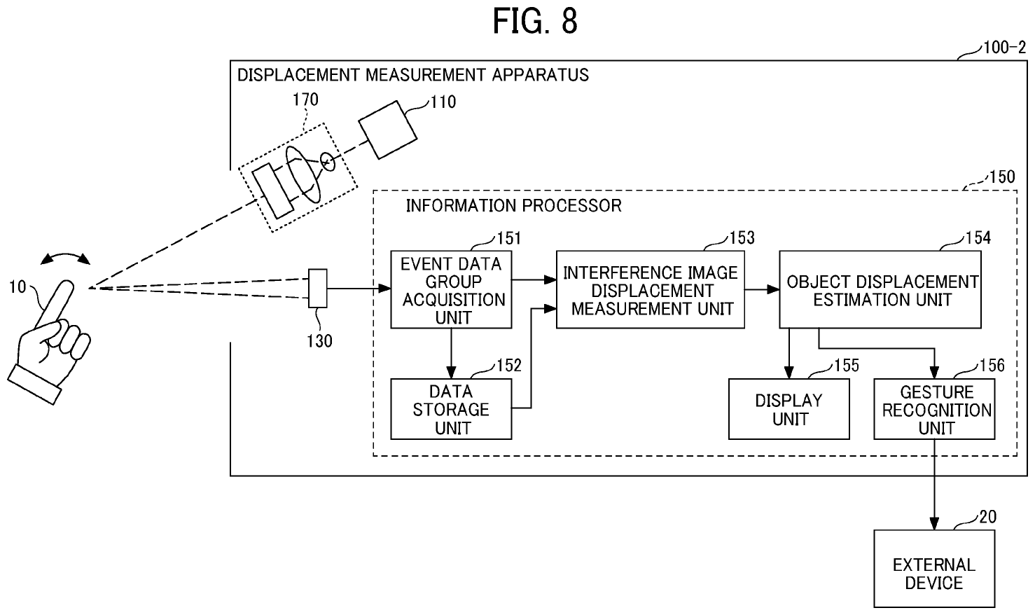

FIG. 8 is a diagram of an overall configuration of a displacement measurement apparatus 100-2 according to the second embodiment. The displacement measurement apparatus 100-2 illustrated in FIG. 8 does not include the interference image forming unit 120 but include the spatial distribution providing unit 170. In this point, the displacement measurement apparatus 100-2 is different from the displacement measurement apparatus 100 illustrated in FIG. 1.

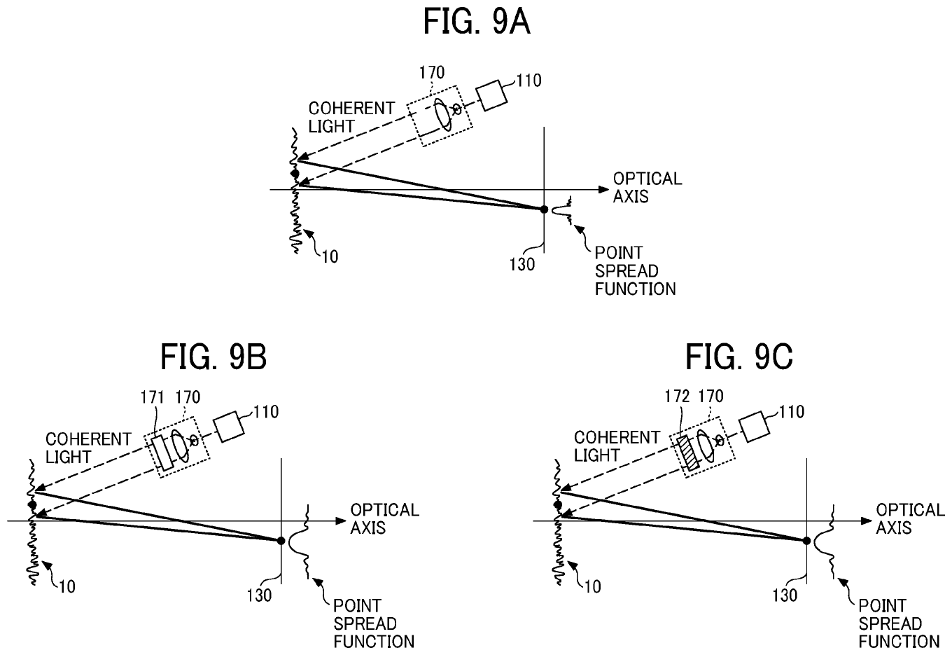

As illustrated in FIG. 8, in the displacement measurement apparatus 100-2, the spatial distribution providing unit 170 is disposed between the light emitter 110 and the object 10 along the optical path of the coherent light. The spatial distribution providing unit 170 has a function of expanding the spatial distribution of the point spread function by spatially expanding the coherent light emitted from the light emitter 110. The spatial distribution providing unit 170 will be described in detail with reference to FIG. 9.

The displacement measurement apparatus 100-2 is configured such that the light reflected by the object 10 is directly incident on the light position detector 130 without passing through a lens. However, the present embodiment is not limited thereto, and the reflected light from the object 10 may be incident on the light position detector 130 through a lens.

In the displacement measurement apparatus, the interference image forming unit limits a spatial distribution of an amplitude or a phase of the reflection light.

### Example of Configuration of Interference Image Forming Unit

FIG. 9 is a diagram of an example of a configuration of the spatial distribution providing unit 170 included in the displacement measurement apparatus 100-2 according to the second embodiment. FIG. 9A is a diagram of a first configuration example of the spatial distribution providing unit 170. FIG. 9B is a diagram of a second configuration example of the spatial distribution providing unit 170. FIG. 9C is a diagram of a third configuration example of the spatial distribution providing unit 170.

In the embodiment illustrated in FIG. 9A, since the spatial distribution providing unit 170 does not have a filter, and the emission region of the coherent light on the object 10 is not adjusted, the distribution of the point spread function (i.e., the size of the speckle particle) in a relatively narrow range is obtained in the light position detector 130.

As described above, when the object 10 is emitted with the coherent light as a parallel light beam, the distribution of the point spread function (i.e., the size of the speckle particle) obtained in the light position detector 130 corresponds to the size of the emission region of the coherent light in the object 10.

Thus, as illustrated in FIGS. 9B and 9C, the displacement measurement apparatus 100-2 according to the second embodiment magnifies the distribution of the point spread function (i.e., the size of the speckle particle) obtained in the light position detector 130 by providing a filter in the spatial distribution providing unit 170.

A displacement measurement apparatus includes: a light emitter to emit coherent light to an object; a light position detector to detect an instantaneous intensity variation of an interference image of the object; and a spatial distribution providing unit disposed between the light emitter and the object along an optical path of the coherent light. The spatial distribution providing unit provides a spatial distribution to the coherent light.

In the displacement measurement apparatus, the spatial distribution providing unit magnifies a point spread function of an optical system to magnify a size of a speckle particle of the interference image.

In the example illustrated in FIG. 9B, the spatial distribution providing unit 170 includes a spatial amplitude filter 171. The spatial amplitude filter 171 is an example of an amplitude modulation filter. In a case where the spatial amplitude filter 171 is used, since the emission region of the coherent light in the object 10 is adjusted by the spatial amplitude filter 171, the distribution of the point spread function (i.e., the size of the speckle particle) magnified as compared with the configuration illustrated in FIG. 9A is obtained in the light position detector 130. As the spatial amplitude filter 171, for example, a aperture may simply be used.

In the displacement measurement apparatus, the amplitude modification filter is an aperture.

In the displacement measurement apparatus, the spatial distribution providing unit includes an amplitude modification filter that partially transmits the reflection light.

Further, as the spatial amplitude filter 171, a filter having a higher transmittance in the vicinity of the optical axis, in which the transmittance changes in a power function manner around the optical axis may be used. In such a case, a characteristic speckle pattern in which speckle particles having a larger size and speckle particles having a smaller size are mixed is formed. Accordingly, the amount of a displacement of the object 10 in a wider speed range from a case where the speed of the displacement of the object 10 is slower to a case where the speed is faster without increasing the size of the measurement optical system is detected.

In the displacement measurement apparatus, a transmittance of the amplitude modification filter exponentially changes from a center of an optical axis of the spatial distribution providing unit.

In the example in FIG. 9C, the spatial distribution providing unit 170 includes a spatial phase filter 172. In a case where the spatial phase filter 172 is used, since the emission region of the coherent light on the object 10 is adjusted by the spatial phase filter 172, the distribution of the point spread function (i.e., the size of the speckle particle) magnified to the same size as when the spatial distribution providing unit 170 is used is acquired in the light position detector 130. In a case where the spatial phase filter 172 is used, since the coherent light is not blocked, the coherent light use efficiency is increased.

The spatial distribution providing unit 170 may use a phase modulation filter that is a computer-generated hologram (CGH) as the spatial phase filter 172.

In the displacement measurement apparatus, the spatial distribution providing unit includes a phase modification filter including a computer generated hologram.

### Effects

As described above, the displacement measurement apparatus 100-2 of the second embodiment includes the light emitter 110 that emits coherent light to the object 10, the light position detector 130 that detects an instantaneous intensity variation of an interference image, and the spatial distribution providing unit 170 that is disposed between the light emitter 110 and the object 10 along the optical path of the coherent light and provides a spatial distribution to the coherent light.

Accordingly, the displacement measurement apparatus 100-2 according to the second embodiment acquires a higher-speed displacement of the interference image caused by the displacement of the object 10 and calculates the amount of the displacement with higher accuracy. Further, in the displacement measurement apparatus 100-2 according to the second embodiment, the spatial distribution providing unit 170 is provided between the light emitter 110 and the object 10, so that the size of the speckle particles of the interference image obtained in the light position detector 130 is adjusted to a size to calculate the amount of a displacement of the object 10 with higher accuracy without increasing the size of the measurement optical system.

Thus, according to the displacement measurement apparatus 100-2 of the second embodiment, a small-sized displacement measurement apparatus to measure the amount of a minute displacement of an object with higher accuracy is provided.

### First Example

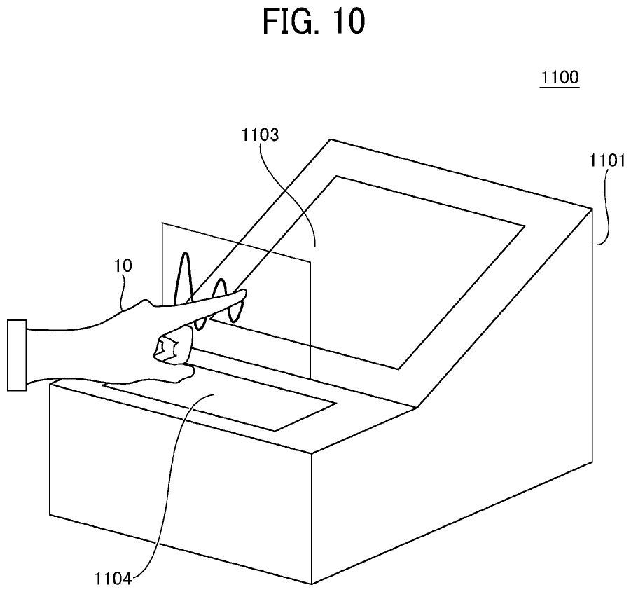

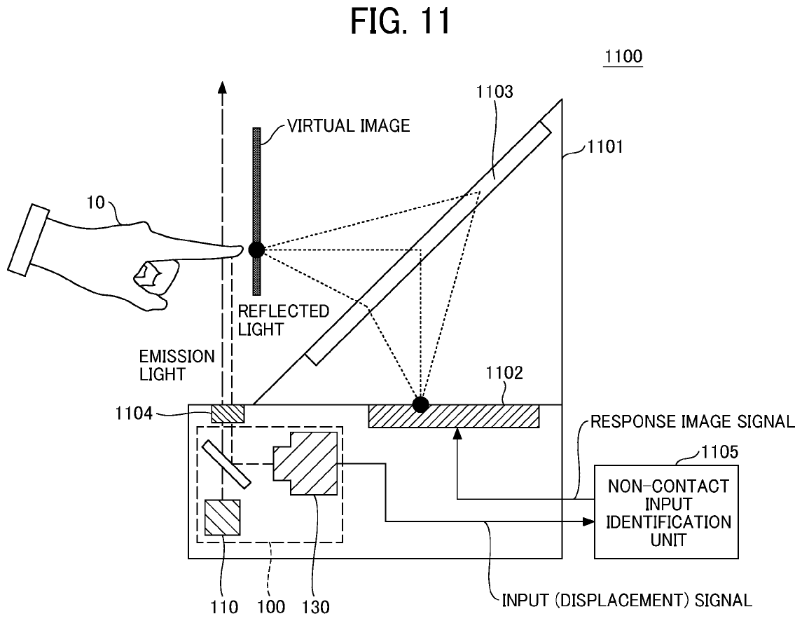

FIG. 10 is a diagram of a non-contact input apparatus 1100 as a first example of the displacement measurement apparatus 100 according to the present embodiment. FIG. 11 is a cross-sectional view of a non-contact input apparatus 1100 that is the first example of the displacement measurement apparatus 100 according to the embodiment.

As illustrated in FIGS. 10 and 11, the non-contact input apparatus 1100 includes a housing 1101, an image display 1102, an imaging plate 1103, an optical window 1104, a non-contact input identification unit 1105, and the displacement measurement apparatus 100. The displacement measurement apparatus in the non-contact input apparatus 1100 may be the displacement measurement apparatus 100 according to the first embodiment or the displacement measurement apparatus 100-2 according to the second embodiment. In addition, the displacement measurement apparatus 100 in the non-contact input apparatus 1100 includes the interference image forming unit 120 or the spatial distribution providing unit 170.

In the non-contact input apparatus 1100, the light emitter 110 in the displacement measurement apparatus 100 emits coherent light as sheet-shaped light toward the upper side and the front side of the housing 1101 (the vicinity of the virtual image formed by the image display 1102 and the imaging plate 1103). When the object 10 crosses the sheet-shaped light in accordance with the non-contact operation of the object 10 (e.g., the finger of the operator) with respect to the virtual image, the reflected light of the sheet-shaped light by the object 10 is incident as an interference image on the light position detector 130 in the displacement measurement apparatus 100 in the housing 1101 through the optical window 1104.

Accordingly, the information processor 150 in the displacement measurement apparatus 100 detects the amount of a minute displacement of the object 10 and outputs information indicating the detected the amount of the minute displacement of the object 10 to the non-contact input identification unit 1105.

The non-contact input identification unit 1105 detects a non-contact operation (e.g., a finger pressing operation, a handwriting operation, or a swipe operation) by the object 10 with higher accuracy based on the information indicating the amount of the minute displacement output from the displacement measurement apparatus 100, and output the detection result to a device to be operated or feedback the detection result to the user.

In the non-contact input apparatus 1100, a virtual image is formed from an image or video information displayed on the image display 1102 using the imaging plate 1103, and the virtual image is displayed above and in front of the housing 1101. As a result, the non-contact input apparatus 1100 is easy to use. As illustrated in FIG. 11, the imaging plate 1103 has functions of transmitting and bending the light, and is formed by a laminated reflection structure.

Since the non-contact input apparatus 1100 includes the displacement measurement apparatus 100, the displacement measurement apparatus 100 quickly and reliably acquires a minute movement of the non-contact operation of the object 10 (e.g., the finger of the operator), that is, the non-contact operation of the object 10 (e.g., the finger of the operator) is detected with higher accuracy.

A non-contact input apparatus includes the displacement measurement apparatus described above.

### Second Example

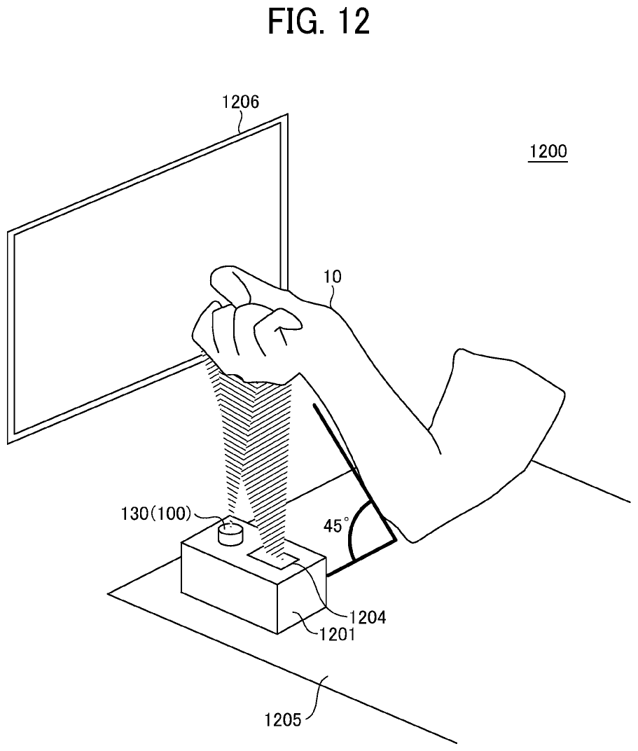

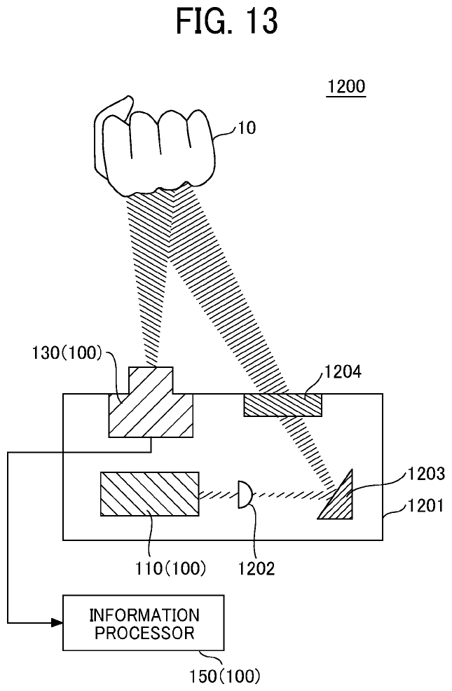

FIG. 12 is a diagram of a tremor measurement apparatus 1200 as a second embodiment of the displacement measurement apparatus 100. FIG. 13 is a cross-sectional view of the tremor measurement apparatus 1200 as a second embodiment of the displacement measurement apparatus 100.

As illustrated in FIGS. 12 and 13, the tremor measurement apparatus 1200 is an example of the biological micromotion measurement apparatus and includes a housing 1201, a cylindrical lens 1202, a folding mirror 1203, an optical window 1204, a support base 1205, a display device 1206, and the displacement measurement apparatus 100. The tremor measurement apparatus 1200 may include any one of the displacement measurement apparatus 100 according to the first embodiment or the displacement measurement apparatus 100-2 according to the second embodiment. Further, the displacement measurement apparatus 100 in the tremor measurement apparatus 1200 includes the interference image forming unit 120 or the spatial distribution providing unit 170.

The tremor measurement apparatus 1200 illustrated in FIGS. 12 and 13 is an apparatus to detect a small vibration (e.g., tremor) of a living body as the object 10. Tremor is an involuntary movement that occurs when muscle contraction and relaxation are repeated, and is typified by shaking of the hand. Tremors is result from, for example, stress, anxiety, fatigue, hyperthyroidism, or alcohol withdrawal. Tremor at rest is regarded as one of the main symptoms of Parkinson's disease.

Typically, the tremor is measured by using a myoelectric potential measurement or an acceleration sensor. Since the tremor measurement apparatus 1200 illustrated in FIGS. 12 and 13 acquires micro-vibration of the object 10 at a micrometer level by using the displacement measurement apparatus 100, tremor is measured with higher accuracy in a non-contact environment.

As illustrated in FIG. 12, the tremor measurement apparatus 1200 measures tremor such that the angle from the elbow to the forearm is 45° with respect to the support base 1205 horizontally set. In the tremor measurement apparatus 1200, the light emitter 110 emits coherent light to the back of the hand, and the light position detector 130 acquires the reflected coherent light reflected by the back of the hand as the interference image.

Accordingly, the information processor 150 included in the displacement measurement apparatus 100 detects the amount of a minute displacement of the object 10. In other words, the information processor 150 measures the tremor of the object 10 with higher accuracy. The tremor data measured by the displacement measurement apparatus 100 is used for understanding the state of a person or as medical data by performing, for example, frequency analysis.

A biological micromotion measurement apparatus includes the displacement measurement apparatus described above.

Although preferred embodiments of the present invention have been described in detail above, the present invention is not limited to these embodiments, and various modifications or changes are made within the scope of the present invention described in the claims below.

For example, the displacement measurement apparatus 100 may include both the interference image forming unit 120 according to the first embodiment and the spatial distribution providing unit 170 according to the second embodiment.

In addition, for example, in the displacement measurement apparatus 100, the interference image forming unit 120 or the spatial distribution providing unit 170 may be provided with an adjusting unit to adjust the distribution of the point spread function depending on the object 10.

In a first aspect, a displacement measurement apparatus includes: a light emitter to emit coherent light to an object; a light position detector to detect an instantaneous intensity variation of an interference image of the object; and an interference imaging forming unit disposed between the object and the light position detector along an optical path of reflection light reflected from the object. The interference imaging forming forms the interference image with the reflection light reflected from the object and magnifies a point spread function of an optical system to magnify a size of a speckle particle of the interference image.

In a second aspect, in the displacement measurement apparatus according to the first aspect, the interference image forming unit includes: an imaging optical element; and
an amplitude modification filter that partially transmits the reflection light.

In a third aspect, in the displacement measurement apparatus according to the first aspect, the interference image forming unit limits a spatial distribution of an amplitude or a phase of the reflection light.

In a fourth aspect, in the displacement measurement apparatus according to the second aspect, the amplitude modification filter is an aperture.

In a fifth aspect, the displacement measurement apparatus according to the first aspect, the interference image forming unit includes an imaging optical element to form an image of the reflection light on a focus position, and the imaging optical element is offset from the focus position toward the light position detector or the object.

In a sixth aspect, in the displacement measurement apparatus according to the first aspect, the interference image forming unit includes an imaging optical element to form an image of the reflection light on a predetermined position, and the light position detector is offset from the predetermined position toward or away from the imaging optical element.

In a seventh aspect, the displacement measurement apparatus according to the fifth aspect or the sixth aspect further includes an offset position variable unit to offset the imaging optical element or the light position detector.

In an eighth aspect, in the displacement measurement apparatus according to any one of the first aspect to the seventh aspect, the light position detector is an event-based vision sensor.

In a ninth aspect, a displacement measurement apparatus includes: a light emitter to emit coherent light to an object; a light position detector to detect an instantaneous intensity variation of an interference image of the object; and a spatial distribution providing unit disposed between the light emitter and the object along an optical path of the coherent light, the spatial distribution providing unit to provide a spatial distribution to the coherent light.

In a tenth aspect, in the displacement measurement apparatus according to the ninth aspect, the spatial distribution providing unit magnifies a point spread function of an optical system to magnify a size of a speckle particle of the interference image.

In an eleventh aspect, in the displacement measurement apparatus according to the tenth aspect, the spatial distribution providing unit includes an amplitude modification filter that partially transmits the reflection light.

In a twelfth aspect, in the displacement measurement apparatus according to the eleventh aspect, a transmittance of the amplitude modification filter exponentially changes from a center of an optical axis of the spatial distribution providing unit.

In a thirteenth aspect, in the displacement measurement apparatus according to the tenth aspect, the spatial distribution providing unit includes a phase modification filter including a computer generated hologram.

In a fourteenth aspect, a non-contact input apparatus includes the displacement measurement apparatus according to any one of the first aspect to the thirteenth aspect.

In a fifteenth aspect, a biological micromotion measurement apparatus includes the displacement measurement apparatus according to any one of the first aspect to the thirteenth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application No. 2021-214739, filed on Dec. 28, 2021, in the Japan Patent Office, the entire disclosure of which is hereby incorporated by reference herein.

### REFERENCE SIGNS LIST

10 Object
20 External device
100 Displacement measurement apparatus
110 Light emitter
120 Interference imaging element
121 Imaging optical element
122 Finite aperture (amplitude modulation filter)
130 Light position detector
150 Information processor
151 Event data group acquisition unit
152 Data storage unit
153 Interference image displacement measurement unit
154 Object displacement estimation unit
155 Display unit
156 Gesture recognition unit
170 Spatial distribution providing unit
171 Spatial amplitude filter
172 Spatial phase filter
200A, 200B Speckle image
210 Event data
210A Increasing component
210B Decreasing component
310, 320 Image
400A, 400B Frame image
410 Increasing component
1100 Non-contact input apparatus
1101 Housing
1102 Image display
1103 Imaging plate
1104 Optical window
1105 Non-contact input identification unit
1200 Tremor measurement apparatus (biological micromotion measuring apparatus)
1201 Housing
1202 Cylindrical lens
1203 Folding mirror
1204 Optical window
1205 Support
1206 Display device

1. A displacement measurement apparatus comprising:
a light emitter to emit coherent light to an object;
a light position detector to detect an instantaneous intensity variation of an interference image of the object; and
an interference image generator disposed between the object and the light position detector along an optical path of reflection light reflected from the object,
the interference image generator to:
form the interference image with the reflection light reflected from the object; and
magnify a point spread function of an optical system to magnify a size of a speckle particle of the interference image.

2. The displacement measurement apparatus according to claim 1, wherein the image generator includes:
an imaging optical element; and
an amplitude modification filter that partially transmits the reflection light.

3. The displacement measurement apparatus according to claim 1, wherein:
the interference image generator limits a spatial distribution of an amplitude or a phase of the reflection light.

4. The displacement measurement apparatus according to claim 2, wherein:
the amplitude modification filter is an aperture.

5. The displacement measurement apparatus according to claim 1, wherein;
the interference image generator includes an imaging optical element to form an image of the reflection light on a focus position, and
the imaging optical element is offset from the focus position toward the light position detector or the object.

6. The displacement measurement apparatus according to claim 1, wherein:
the interference image generator includes an imaging optical element to form an image of the reflection light on a predetermined position, and
the light position detector is offset from the predetermined position toward or away from the imaging optical element.

7. The displacement measurement apparatus according to claim 5, further comprising:
an offset positioner to offset the imaging optical element or the light position detector.

8. The displacement measurement apparatus according to claim 1, wherein;
the light position detector is an event-based vision sensor.

9. A displacement measurement apparatus comprising:
a light emitter to emit coherent light to an object;
a light position detector to detect an instantaneous intensity variation of an interference image of the object; and
a spatial distributor disposed between the light emitter and the object along an optical path of the coherent light, the spatial distributor to provide a spatial distribution to the coherent light, the spatial distributor including a spatial amplitude filter and a spatial phase filter,
wherein the spatial distributor magnifies a point spread function of an optical system to magnify a size of a speckle particle of the interference image.

10. (canceled)

11. The displacement measurement apparatus according to claim 9, wherein:
the spatial distributor includes an amplitude modification filter that partially transmits the reflection light.

12. The displacement measurement apparatus according to claim 11, wherein:
a transmittance of the amplitude modification filter exponentially changes from a center of an optical axis of the spatial distributor.

13. The displacement measurement apparatus according to claim 9, wherein:
the spatial distributor includes a phase modification filter including a computer generated hologram.

14. A non-contact input apparatus comprising:
the displacement measurement apparatus according to claim 1.

15. A biological micromotion measurement apparatus comprising:
the displacement measurement apparatus according to claim 1.
